(19) United States
(12) Patent Application Publication
(10) Pub. No.: US 2015/0127433 A1
(43) Pub. Date: May 7, 2015

(54) METHODS AND SYSTEMS OF PROVISIONING DISCOUNTS BASED ON TRAVEL DISTANCE

(71) Applicants: Thirunarayanan Srinivasan, Highlands Ranch, CO (US); Ramesh Ramamurthy, Highlands Ranch, CO (US); Krishnan Kannan, Englewood, CO (US)

(72) Inventors: Thirunarayanan Srinivasan, Highlands Ranch, CO (US); Ramesh Ramamurthy, Highlands Ranch, CO (US); Krishnan Kannan, Englewood, CO (US)

(21) Appl. No.: 14/025,800

(22) Filed: Sep. 12, 2013

(51) Int. Cl. G06Q 30/02; G06Q 20/10

(52) U.S. Cl. CPC G06Q 30/0207; G06Q 30/0234; G06Q 20/10
USPC 705/14.1

(57) ABSTRACT

In view of the foregoing, embodiments herein provide methods and systems for providing discounts on basic price of services and/or products, wherein the method comprises allowing a user to select and book at least a service and/or product using a user device, identifying position of the user and a destination of booked service and/or product are available, calculating a predetermined radius from the destination, wherein the predetermined radius is an origin, calculating “as-the-crow-flies” travel distance of the user towards the destination during the user traveling within the origin, applying discounts on basic price of the booked service and/or product, wherein the discounts are dynamically applied based on the travel distance to determine dynamic discounted price, allowing the user to avail the discounts for the booked service and/or product; and allowing the user to make or authorize payment for the booked service and/or product.

### BACKGROUND

1. Technical Field

The embodiments herein generally relate to e-commerce platform. Specifically, the embodiments described herein relate to methods and systems for providing discounts to users based on their distance traveled for the last moment bookings of services and/or products.

2. Description of Related Art

Conventionally, the success of any product or service is measured by the service quality of the merchant offering and satisfaction of the customers. The merchant wants to make their services profitable while ensuring that customer satisfaction also plays an important role. In order to achieve both, a strong relationship must exist between the customer and merchant in a meaningful way. Customers feel happy when they are offered a product with excellent service.

In general, a merchant can attract customers by various techniques like running campaigns, soliciting feedback, running a rewards programs, etc. Beyond these techniques, providing discounts tend to attract customers in the most dynamic way. Discount [or, discounts] is basically a reduction to the basic price of goods or services. The main motto of the discount is to increase short term sales, to move out-of-date stock, to reward valuable customers, to offer seasonal discount, etc. As people are price conscious giving more attention to total savings, discount plays an important role in claims of savings earned related to the purchase of products or services.

The current available systems in price savings relate to online and offline discounts. Merchants are interested to give more discounts to people who visit their stores on a regular frequency basis. Generally, an offline discount is offered in the form of an absolute price reduction or discount percentage for presentation of physical coupons in-store. On the other hand, an online discount system ensures that merchants can afford to market their business with easy budget-friendly methods. Some types of online discounts are coupon/promotion codes, deals, free shipping, etc.

Generally, an online coupon is a ticket that can be exchanged for a financial discount when purchasing a product or service. The online retailer refers to the coupon as coupon code, promotion code, discount code, key code, surplus code, portable code, shopping code, voucher code, reward code, discount voucher, or source code. On the other hand, deals are likely to be in the form of “If you spend more, you can save more.” Other types of deals include percentage off deals, group buying deals, geo referenced mobile deals, etc. Online discounts normally ensures some of the offers like free shipping, discounts for immediate booking, discounts for new members, a specific amount or percentage discount, volume discount, membership level discounts, or seasonal discounts to encourage consumers to purchase specific products or services. Hence, in recent years, online discount seems to be more popular in many sales of services or products because of their saving potential.

However, people traveling to receive services or to buy products at stores are not pre-planned in this world and, as such, they find it hard to receive discounts and/or offers for products or services at the last moment. Additionally, the present bookings system does not allow the customers to get offers and/or discounts during traveling.

Hence, there exists a need in the art to develop a lively, forceful and active methods and systems for savings on prices of products or services in a significant way. Such type of methods and systems should offer real benefit to the users/customers for their booking of services and/or services based on their travel distance. Specifically, there exists a need to provide methods and systems which can provide price discounts to users who are making bookings for products or services at the last moment while taking into consideration the distance traveled by them.

### SUMMARY

In view of the foregoing, embodiments herein provide methods and systems for providing discounts on basic price of services and/or products be utilized for online booking of at least a service and/or product and making payment of booked service and/or product, in which users utilizing a user device can book in advance or same day of travel or during travel to one or more destinations, where services and/or products are made available, and avail discounts applied to basic price of services and/or products based on their “as-the-crow-flies” travel distance towards the destination.

In an example, a method of providing discounts for services and/or products, wherein the method comprises allowing at a user to select and book at least a service and/or product using a user device, based on identifying the position of the user and a destination, where services and/or products are made available, calculating a predetermined radius from the destination, wherein the predetermined radius is an origin, calculating “as-the-crow-flies” travel distance of the user towards the destination during the travel within the origin, applying discount on the basic price of the booked service and/or product, wherein the discount is dynamically applied based on the travel distance to determine the dynamic discounted price, allowing the user to avail the discount for the booked service and/or product; and allowing the user to make or authorize payment for the booked service and/or product, wherein the payment is performed using the user device, wherein the user travels to the destination using a travel mode, wherein the travel mode includes walking and driving using a vehicle.

In an example, the method further comprises not applying the discounts upon reaching a predetermined distance from the destination, not applying the discounts while the user traveling away from the destination, and not applying the discounts in outside the origin region, wherein the predetermined distance is a curbside.

In an example, the method further comprises applying a minimum amount of the discount at start of the origin, applying further discounts up to the curbside while traveling towards the destination, and applying maximum amount of the discounts upon reaching the curbside.

In an example, the method further comprises allowing the user to make or authorize payment for the basic price of the booked service and/or product in advance before traveling to the destination and in outside the origin region, and allowing the user to make or authorize payment for dynamic discounted price of the booked service and/or product during travel towards the destination within the origin.

In an example, the method further comprises allowing the user to avail the discounts as refund from the payment made, and to complete the payment transaction after deducting the applied discounts from the authorized payment.

In an example, the user device is configured to display data of the services and/or products based on position of the user. In an embodiment, the user device is integrated with a global positioning system [GPS] receiver capable of identifying and tracking the position. In another embodiment, the user device is in connection and communication with a navigation system capable of identifying and tracking the position.

A system of providing discounts for services and/or products, wherein the system comprising at least a user device includes a booking discount engine, a network, a backend server which includes a database and a backend server engine; and at least an interface device for permitting merchants to interact with the backend server, wherein the database stores data related to the services and/or products, wherein the interface device facilitates transmitting and receiving the data from the backend server over the network, wherein the merchants upload and manage the data of the products and/or services in the database.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not by way of limitation. Many changes and modifications may be made within the scope of the embodiments herein without departing from the spirit thereof, and the embodiments herein include all such modifications.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference number in different figures indicates similar or identical items.

FIG. 1 illustrates a schematic diagram for implementing systems and methods of providing discounts for services and/or products in accordance with an example embodiment herein;

FIG. 2 illustrates a sample network environment within which systems and methods of providing discounts for services and/or products based on travel distance from predetermined radius in accordance with an example embodiment herein;

FIG. 3 illustrates a flowchart showing method of providing discounts for services and/or services in accordance with an example embodiment herein;

FIG. 4 illustrates a flowchart showing method for hotel booking services in accordance with an example embodiment herein;

FIG. 5 illustrates a flowchart showing method for restaurant booking services in accordance with an example embodiment herein;

FIG. 6 illustrates a block diagram of a booking discount engine for providing discounts based on travel distance from predetermined radius in accordance with an example embodiment herein; and

FIG. 7 illustrates a block diagram of a backend server engine for providing discounts based on travel distance from predetermined radius in accordance with an example embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those skilled in the art to practice the embodiments herein. Accordingly, the examples should not be construed as limiting the scope of the embodiments herein.

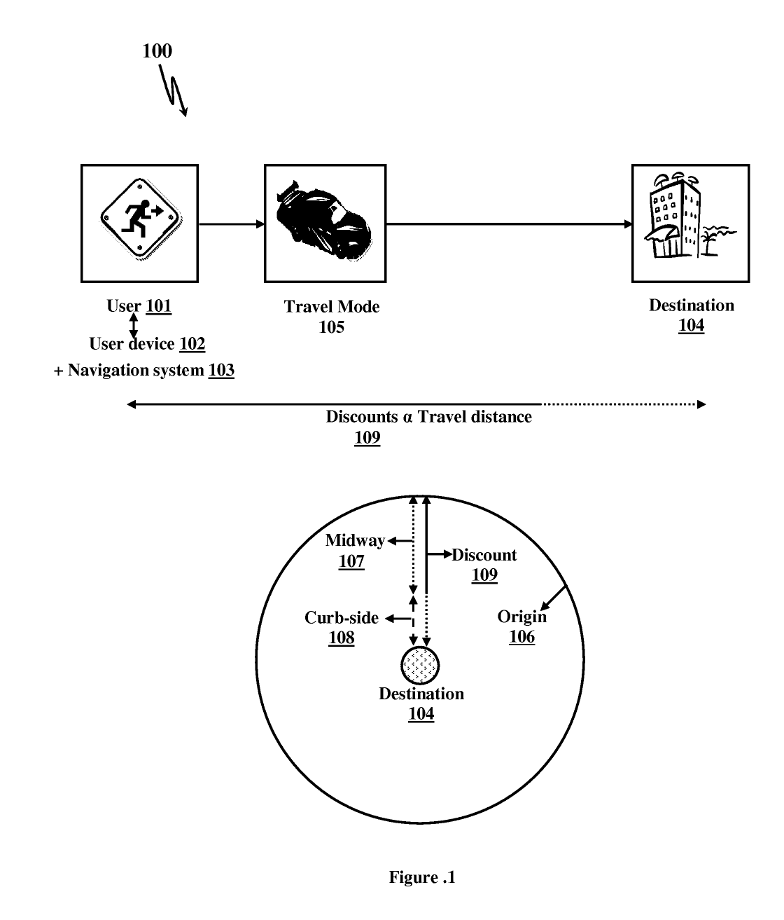

As mentioned above, there is a need to provide methods and systems of providing discounts for services and/or products based on travel distance. The embodiments herein achieve this by providing computing device architecture for implementing systems and methods which can enable a user to book at least a service and/or product using a user device integrated with GPS receiver or a user device along with a navigation system. Referring now to the drawings, and more particularly to FIGS. 1 through 7, where same reference numbers denote corresponding features consistently throughout the figures, there are shown preferred embodiments. As used herein, the term “and/or,” when used in a list of two or more items, means that any one of the listed items can be employed by itself, or any combination of two or more of the listed items can be employed.

In some example embodiments, methods and systems for providing discounts on basic price of services and/or products can be utilized for online booking of at least a service and/or product, in which users can book in advance or same day of travel or during travel to avail the services and/or buy the products. The services can include among other, hotels, restaurants, taxis, car rentals, vacation rentals, airlines, sports events and entertainment events. The products can include both retail and wholesale items purchasable in-stores. The systems and methods described herein can be utilized for discounts on the basic prices of services and/or products either monetary or non-monetary, or both.

FIG. 1 illustrates a schematic diagram 100 for implementing systems and methods of providing discounts for products and/or services to users based on their travel distance preferably based on “as-the-crow-flies,” according to example embodiments. Accordingly, the user 101 can book for services and/or products using a user device 102. In one embodiment, the user device 102 is integrated with a global positioning system [GPS] receiver. In another embodiment, the user device 102 is in connection and communication with a navigation system 103, wherein the connection can be wired or wireless. The GPS receiver and/or navigation system 103 may be used to identify and track the position of the user 101 and one or more destination 104, where at least a service and/or product is made available. In various example embodiments, the user device 102 operates as a standalone device or may be connected (e.g. networked) to other devices. The user device 102 can include but not limited to a mobile telephone, a tablet, a laptop, a personal digital assistant [PDA], a GPS device, a smartphone, a web appliance, or any device capable of executing a set of instructions (sequential or otherwise) that specify actions to be taken by that device. Further, while only a user device is illustrated, the term “user device” shall also be taken to include any collection of devices that individually or jointly execute a set (or multiple sets) of instructions to perform any one or more of the methodologies discussed herein.

In some example embodiments, the user device 102 can be configured to display data of the products and/or services such as name, address, information about merchant's facility, availability, amenities, regular price, basic price, discounted price, customer reviews, user reviews, distance to destination address from user's current location, checkin date, checkout date, and an option to drive to the destination address.

In some example embodiments, the user 101 can utilize the user device 102 to view or sort or select and book the products and/or services in advance or same day of travel or during travel to one or more destination 104 by using a travel mode 105, wherein the travel mode 105 can include driving using a vehicle, wherein the navigation system 103 may be made available within the vehicle, and walking. In some example embodiments, the user 101 can utilize the user device 102 to make payment or cancel the booking of the products and/or services.

In some example embodiments, the user device 102 can be configured to display the number of users driving to a destination at the same time, the user that is closest to the destination and the user that is farthest from the destination, after selecting a product or service from the list of products or services displayed.

In some example embodiments, the user device 102 can be configured to play one or more pre-recorded audio advertisements related to the selected or booked products and/or services at predefined intervals while traveling towards the destination 104 of the selected products and/or services. In some example embodiments, the user device 102 can be configured to play one or more pre-recorded audio advertisements related to a plurality of products and/or services based on the distance from the user device 102 to the destination 104.

In a preferred embodiment, the user 101 can view and/or avail discounts 109 applied on the basic price of services and/or products, wherein the discounts 109 can be computed dynamically based on the traveling distance by the user 101 while traveling towards one or more destination 104 and the discounts 109 may not be computed while traveling away from the destination 104, wherein the discounts 109 are proportional to the travel distance preferably based on “as-the-crow-flies” while traveling towards the destination 104. In another embodiment, the user 101 can view and/or avail discounts 109 to be applied to the basic price of services and/or products, wherein the discounts 109 can be computed dynamically based on the distance to be traveled by the user towards the destination 104.

In some example embodiments, minimum amount of discount and maximum amount of discount can be defined and computed based on one or more parameters associated with the services and/or products; for example, basic price, markup of the basic price, duration of stay, number of rooms, number of persons booked, etc. In some example embodiments, discount per unit distance can be computed dynamically using the maximum amount of discount and distance to travel to the destination 104 within a predetermined radius from the destination 104. In some example embodiments, the difference between the basic prices of services and/or products and discounts 109 applied on the basic price based on distance traveled may be referred as dynamic discounted price.

In a preferred embodiment, the discounts 109 applied on basic price of the services and/or products may be equal to the distance traveled between two consecutive geographic points multiplied by the dynamically computed discount per unit distance.

In some example embodiments, the predetermined radius from the destination 104 may be referred as origin 106 of the destination 104. The minimum amount of discounts 109 on the basic price of services and/or products may start at the origin 106, and further discounts may be applied while traveling towards the destination 104. The discounts 109 may not be applied outside the origin 106. In some example embodiments, the discounts 109 may not be applied when the user 101 moves away from the destination 104 while traveling within the origin 106. Accordingly, the user 101 can avail discounts dynamically applied on the basic price of services and/or products based on the travel distance preferably “as-the-crow-flies” from the origin 106 and towards the destination 104.

In some example embodiments, a predetermined distance from the destination 104 may be referred as curbside 108. The maximum amount of discounts may be applied upon reaching the curbside 108 and the discounts 109 may not be applied within the curbside 108 of the destination 104. Accordingly, the user 101 can avail discounts dynamically applied on the basic price of services and/or products based on the travel distance preferably “as-the-crow-flies” from the origin 106 up to the curbside 108 of the destination 104.

In some example embodiments, the distance from origin 106 to the curbside 108 may be referred to as the midway 107. The discounts 109 on the basic price of services and/or products may be applied within the midway 107. Accordingly, the user can avail the discounts 109 applied dynamically on the basic price of services and/or products based on the distance traveled within the midway 107 towards the destination 104.

In some example embodiments, in the outside origin 106 region, the user 101 can view or sort or select and book in advance at least a service and/or product, make or authorize full payment of basic price of the booked service and/or product, and can avail discounts 109 while traveling towards the destination 104. The discounts 109 may stop and be marked while the user 101 stops at any place before reaching to destination 104. Further, the discounts 109 may restart from the marked discounts while the user 101 starts traveling towards the destination 104.

In some example embodiments, in the outside origin 106 region or in the origin 106 region, the user 101 can view or sort or select and book in advance at least a service and/or product, make or authorize full payment of basic price of the booked service and/or product, and can avail discounts 109 as refund from the payment made or complete the payment transaction after deducting the discounts 109 from the authorized payment while traveling between the origin 106 and curbside 108 towards the destination 104, wherein the payments can be performed using known methods.

In some example embodiments, in the outside origin 106 region or in the origin 106 region, the user 101 can view or sort or select and book in advance at least a service and/or product, make or authorize payment of dynamic discounted price of the booked service and/or product in the midway 107 region, and can avail further discounts 109 as refund from the payment made or complete the payment transaction after deducting the discounts 109 from the authorized payment while traveling between the origin 106 and curbside 108 towards the destination 104, wherein the payments can be performed using known methods.

In some example embodiments, the user 101 can view or sort or select and book at least a service and/or product in outside the origin 106 region or in the origin 106 region, and make or authorize payment of dynamic discounted price of the booked service and/or product in the curbside 108. In some example embodiments, booking of selected service and/or product may be confirmed after making or authorizing the payment.

In some example embodiments, in the midway 107 region, the user 101 can view or sort or select and book at least a service and/or product and make or authorize payment of dynamic discounted price of the booked service and/or product, and can avail further discounts 109 as refund from the payment made or complete the payment transaction after deducting the further discounts 109 from the authorized payment.

In some example embodiments, the user 101 can view or sort or select and book at least a service and/or product in outside the origin 106 region or in the origin region or in the midway 107 region or in curbside 108 region, and make or authorize payment of dynamic discounted price of the booked service and/or product at the destination 104.

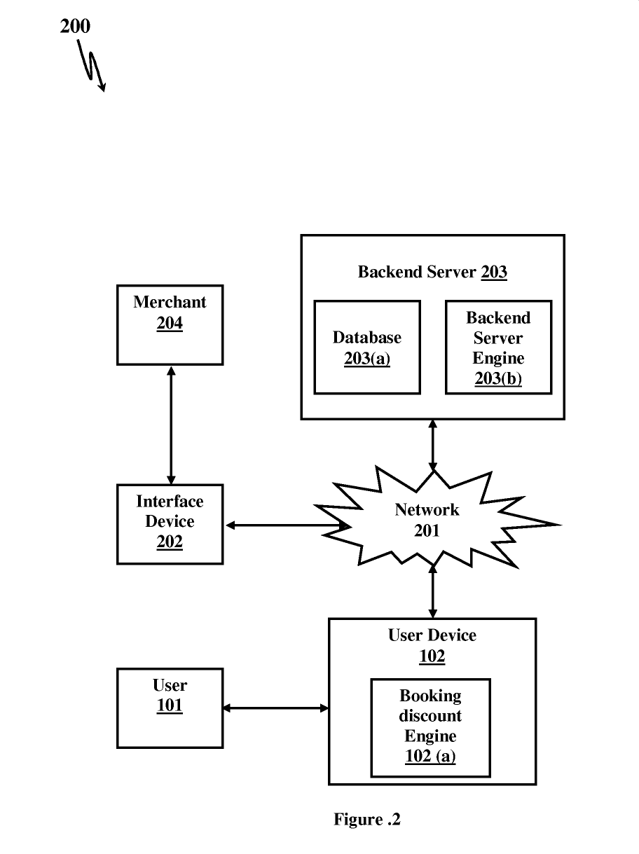

FIG. 2 illustrates a sample network environment 200 within which systems and methods of providing discounts for services and/or products based on travel distance are applicable in accordance with an example embodiment. As shown in FIG. 2, the sample network environment 200 may comprise a network 201 (e.g. cellular network), an interface device 202, a user device 102 which includes a booking discount engine 102(a), and a backend server 203 which includes a database 203(a) and a backend server engine 203(b). The network 201 can comprise a plurality of data processing nodes interconnected for the purpose of data communication. Other components of the network environment 200 can utilize the network 201 to receive, transmit, and store data as well as for the purpose of accessing remote resources.

The database 203(a) may be utilized to store data processed by the backend server engine 203(b) and/or the booking discount engine 102(a). The database 203(a) can store data related to products and/or services. The interface device 202 can be included in various devices, including portals to facilitate transmitting and receiving data over the network 201. The interface device 202 can permit one or more merchants 204 to interact with the backend server engine 203(b), wherein the merchants 204 can include owner, retailer, service provider such as hotelier and restaurateur, manager, and authorized personnel of the merchants for the products and/or services.

In some example embodiments, the merchants 204 can utilize the interface device 202 to connect and communicate with the backend server 203 via network 201 in order to upload and manage the data of the products and/or services in the database 203(a). The data related to the products and/or services can include name, address, information about merchant's facility, inventory, availability, regular price, basic price, customer reviews, user reviews, checkin date, checkout date, photos of rooms, dishes, stores, and fleet of cars, etc.

In some example embodiments, the user device 102 can send booking data of the users related to booked services or products to the backend server 203 to store in database 203(a), wherein the booking data can include user name, address, booking date, basic price, discount price, payment information, cancellation, etc. The booking data in the database 203(a) can be accessible by relevant merchants 204 for the booking.

In some example embodiments, the user 101 can utilize the user device 102 to view or sort or select and book the products and/or services and also make payment for the booked products and/or services, wherein the data of the products and/or services can be received from the backend server 203 via the network 201. The user device 102 can display the available products and/or services and/or destination of the available products and/or services based on the user device 102 location.

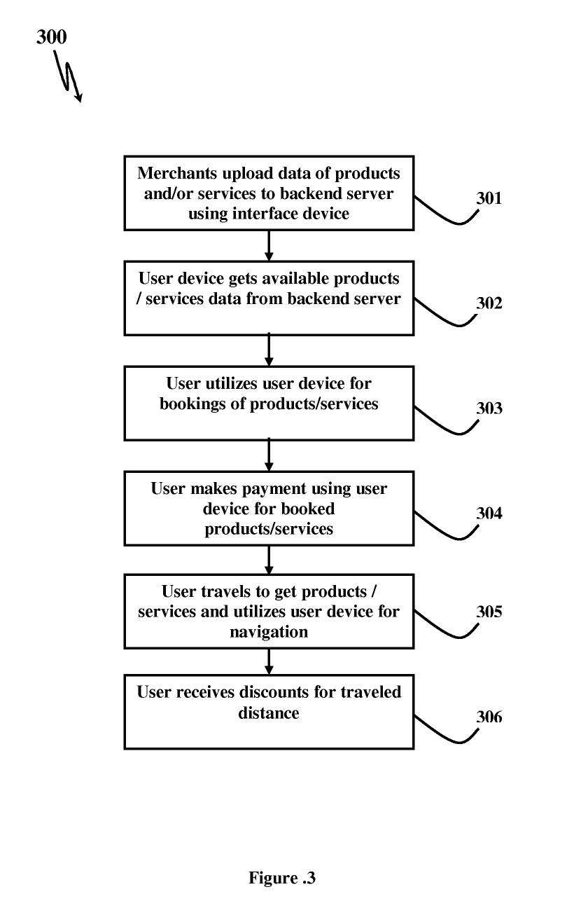

Exemplary methods for implementing system of providing discounts for products and/or services based on travel distance using user device are described with reference to FIG. 3 to FIG. 5. The methods are illustrated as a collection of operations in a logical flow graph representing a sequence of operations that can be implemented in hardware, software, firmware, or a combination thereof. The order in which the methods are described is not intended to be construed as a limitation, and any number of the described method blocks can be combined in any order to implement the methods, or alternate methods. Additionally, individual operations may be deleted from the methods without departing from the spirit and scope of the subject matter described herein. In the context of software, the operations represent computer instructions that, when executed by one or more processors, perform the recited operations.

FIG. 3 illustrates a flow chart 300 for methods of providing discounts for products and/or services based on travel distance in accordance with an example embodiment. At block 301, the merchants 204 can upload and manage the data of the products and/or services to the database 203(a) of backend server 203 using interface device 202. This is essential for the merchants 204 to provide the inventory data of products/services to the user 101. The merchants 204 can view the details of the booking, payments, and discounts for the users from the backend server 203 using interface device 202.

At block 302, the user device 102 can receive available products and/or services data from the backend server 203. All the respective data corresponding to the available products and/or services can be fetched in the user device 102 based on the location of the user 101. The user device 102 can receive and display the available services and/or services data along with name, address, information about service facility, regular price, sell price, discounted price, user reviews, customer reviews, distance to destination address from user's current location, and an option to drive to the destination address. Thus, the user 101 is able to choose at least an available product or service based on user's requirement to avail discounts on basic price of products and/or services.

At block 303, the user 101 can select at least an available product or service and then do bookings at outside or inside origin 106 region in advance or same day of travel or while traveling towards the destination 104 of the selected products or services with the aid of user device 102. The details of the bookings for products and/or services can be further directed to the backend server 203.

At block 304, the user 101 can make full or partial payment or authorize payment of basic price at outside origin 106 region, or make or authorize payment of discounted price in inside origin 106 region for confirmation of the booked products and/or services with the aid of user device 102 using known payment methods and techniques for processing the payment, and the payments details can be directed to the backend server 203.

At block 305, the user 101 can travel to the destination 104 of selected or booked or paid products and/or services and can utilize the user device 102 for navigation. The booking discount engine 102(a) provided in the user device 102 can compute minimum amount of discount, maximum amount of discount, the traveled distance towards the destination 104 and dynamic discounted price for providing discounts to the user 101. The details of the discounts can be further directed to the backend server 203.

At block 306, the user 101 can avail the discounts 109 applied on basic price of selected or booked products and/or service based on “as-the-crow-flies” traveled distance towards the destination 104. The user 101 can also avail the refund at the destination 104 for the discounts applied on basic price of paid products and/or service based on “as-the-crow-flies” traveled distance towards the destination 104.

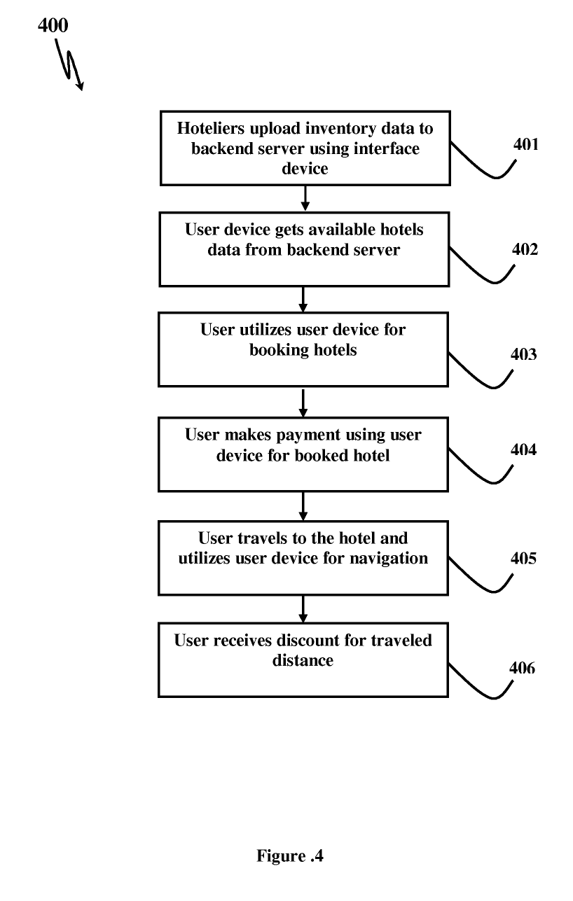

FIG. 4 illustrates a flowchart 400 showing method for hotel booking service, in accordance with an example embodiment. This method can allow the user 101 to book at least an available hotel in advance or same day of travel or while traveling towards the hotel, and can avail discounts 109 based on their traveling distance preferably from origin 106 towards the hotel.

At block 401, the merchants 204 particularly hoteliers can upload and manage the inventory data of the hotels in the database 203(a) of backend server 203 using interface device 202 including a hotelier portal, wherein the inventory data can include hotel name, hotel address, hotel facility, available number of rooms, tariff (basic price), and location of the hotel. The hoteliers can view the details of the booking, payments, and discounts of the users from the backend server 203 using interface device 202.

At block 402, the user device 102 can receive the available hotels data from the backend server 203 preferably surrounding available hotels of the user device 102 location. All the inventory data corresponding to the available hotels can be fetched in the user device 102 based on the location of the user 101. The user device 102 can receive and display the available hotels inventory data, along with user reviews, customer reviews, regular price, basic price, discounted price, distance to hotel address from user's current location, and an option to drive to the hotel address. Thus, the user 101 is able to choose at least an available hotel based on user's requirement to avail discounts 109 on tariff price of hotels.

At block 403, the user 101 can select at least an available hotel and then do bookings at outside or inside origin 106 region in advance or same day of travel or during traveling towards the hostel with the aid of user device 102. The details of the hotel bookings can be further directed to the backend server 203.

At block 404, the user 101 can make full payment or partial payment or authorize payment at the outside or inside origin 106 region for the confirmation of booked hotels with the aid of user device 102 using known payment methods and techniques for processing the payment, and the payments details can be directed to the backend server 203.

At block 405, the user 101 can travel to the destination 104 [i.e. hotel] of selected or booked or paid hotels and can utilize the user device 102 for navigation. The booking discount engine 102(a) provided in the user device 102 can compute minimum amount of discount, maximum amount of discount, the traveled distance towards the destination 104 [i.e. hotel], and dynamic discounted price for providing discounts 109 to the user 101. The details of the discounts can be further directed to the backend server 203.

At block 406, the user 101 can avail the discounts 109 applied on tariff price of selected or booked hotels based on “as-the-crow-flies” traveled distance preferably within the midway 107 region. The user 101 can also avail the refund at the destination 104 [i.e. hotel] for the discounts applied on tariff price of hotel based on “as-the-crow-flies” traveled distance towards the destination 104.

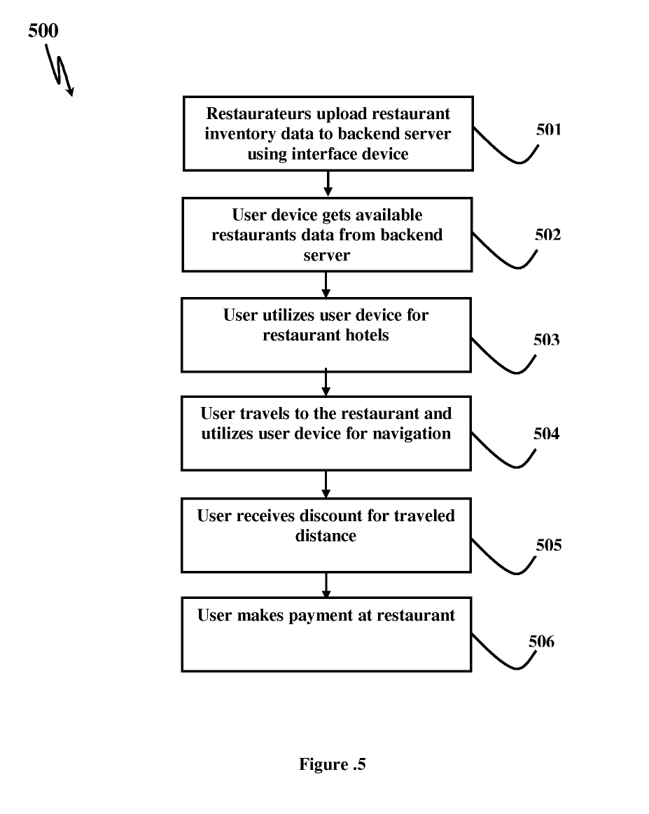

FIG. 5 illustrates a flowchart 500 showing method for restaurant booking service, in accordance with an example embodiment. This method can allow the user 101 to book at least a restaurant in advance or same day of travel or during traveling towards the restaurant, and can avail discounts 109 based on their traveling distance preferably from origin towards the restaurant.

At block 501, the merchants 204 particularly restaurateurs can upload and manage the inventory data of the restaurants to the database 203(a) of backend server 203 using interface device 202 including a restaurateur portal, wherein the inventory data can include restaurant name, restaurant address, restaurant facility, menu, price list, and location of the restaurant. The restaurateurs can view the details of booking, payments, and discounts of the users from the backend server 203 using interface device 202.

At block 502, the user device 102 can receive the restaurants data from the backend server 203 preferably surrounding restaurants of the user device 102 location. All the inventory data corresponding to the restaurants can be fetched in the user device 102 based on the location of the user 101. The user device 102 can receive and display the restaurants inventory data, along with user reviews, customer reviews, price information, distance to restaurant address from user's current location, and an option to drive to the hotel address. Thus, the user 101 is able to choose at least a restaurant based on user's requirement to avail discounts 109 on tariff price of restaurants.

At block 503, the user 101 can select at least a restaurant and then do bookings at outside or inside origin 106 region in advance or same day of travel of travel or during traveling towards the restaurant with the aid of user device 102. The details of the restaurant bookings can be further directed to the backend server 203.

At block 504, the user 101 can travel to the destination 104 [i.e. restaurant] of selected or booked restaurant and can utilize the user device 102 for navigation. The booking discount engine 102(a) provided in the user device 102 can compute minimum amount of discount, maximum amount of discount, the traveled distance towards the destination 104 and dynamic discounted price for providing discounts 109 to the user 101. The details of the discounts can be further directed to the backend server 203.

At block 505, at the destination 104, the user 101 can avail the discounts 109 applied on bill amount from the selected or booked restaurant based on “as-the-crow-flies” traveled distance.

At block 506, the user 101 can make payment for the discounted price of billed amount at the destination 104 either using the user device 102 or using known payment methods and techniques for processing the payment, and the payments details can be directed to the backend server 203.

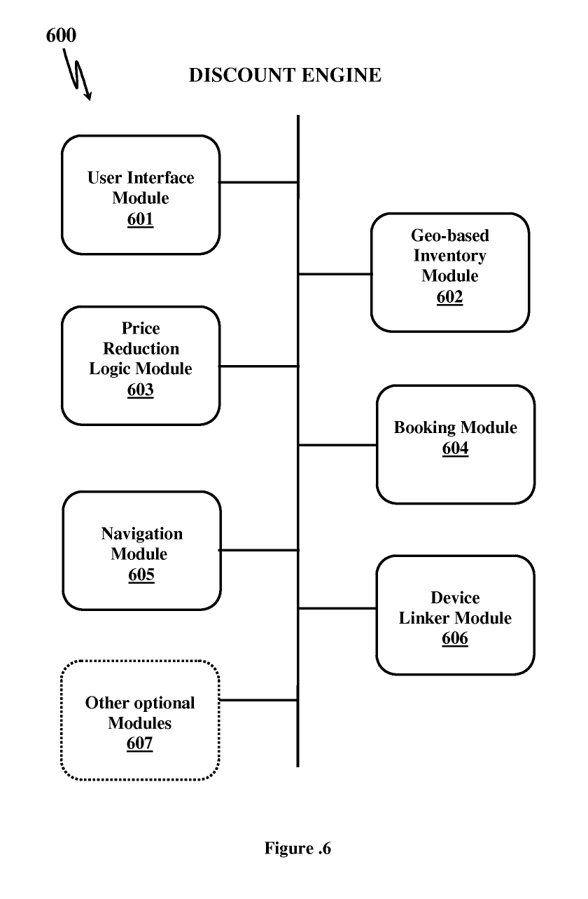

FIG. 6 illustrates a block diagram 600 of a booking discount engine 102(a) in accordance with an example embodiment. The booking discount engine 102(a) can be utilized to process the booking, payment, cancellation and discounts of products and/or services. The booking discount engine 102(a) can use the network 201 at least at some point in the transaction's lifecycle, although it may comprise a wider range of technologies.

The booking discount engine 102(a) can include several components that may be configured to perform various operations. As shown in FIG. 6, the booking discount engine 102(a) can comprise a user interface module 601, a geo-based inventory module 602, a price reduction logic module 603, a booking module 604, a navigation module 605, a device linker module 606, and other optional modules 607. The components of the booking discount engine 102(a) can facilitate an online booking of products and/or services.

In an embodiment, the user interface module 601 can manage all user interactions dealing with capturing user requests related to products and/or services. Further, it can display the list of available products and/or services details from merchants 204. Further, the user interface module can enable the users for selection, booking, payment, payment modification and cancellation of bookings of services and/or products.

In an embodiment, the geo-based inventory module 602 can receive and display the details/data of products and/or services based on the user 101 location from the backend server 203. The details of the products and/or services can include name, address, information about service facility, regular price, basic price, user reviews, customer reviews, checkin date, checkout date, etc.

In an embodiment, the price reduction logic module 603 can run at a predetermined interval to identify discounts 109 of the products and/or services based on the user's requirements and within origin 106 region. The price reduction logic module 603 can compute minimum amount of discount, maximum amount of discount, the traveled distance preferably “as-the-crow-flies” towards the destination 104 and dynamic discounted price for providing discounts to the user 101. Further, the price reduction logic module 603 can send the discounts 109 details to the backend server 203.

In an embodiment, booking module 604 can enable the user 101 to perform booking, modification, and cancellation functions for the products and/or services. The booking module 604 can handle payments and refunds i.e. driving discounts 109 on the card and also displays the dynamic discounted price. Additionally, the booking module 604 can show an option to help the user to complete the booking at outside origin 106 region or at midway 107 or upon reaching curbside 108. Further, the booking module 604 can transmit the booking details to the backend server 203.

In an embodiment, navigation module 605 can help the user 101 with driving directions (preferably voice-guided) to find the shortest path to the destination 104. The navigation module 605 can announce the discounts 109 and dynamic discounted price from time to time while traveling towards the destination 104 within the origin 106 region.

In an embodiment, device linker module 606 can enable to link the user device 102 with the navigation system 103, so that the location of the user 101 and destination 104, distance between the user 101 and destination 104 can be received at user device 102 from the navigation system 103. In a further embodiment, the basic price and dynamic discounted price can be received at user device 102 from the navigation system 103 through the backend server 203.

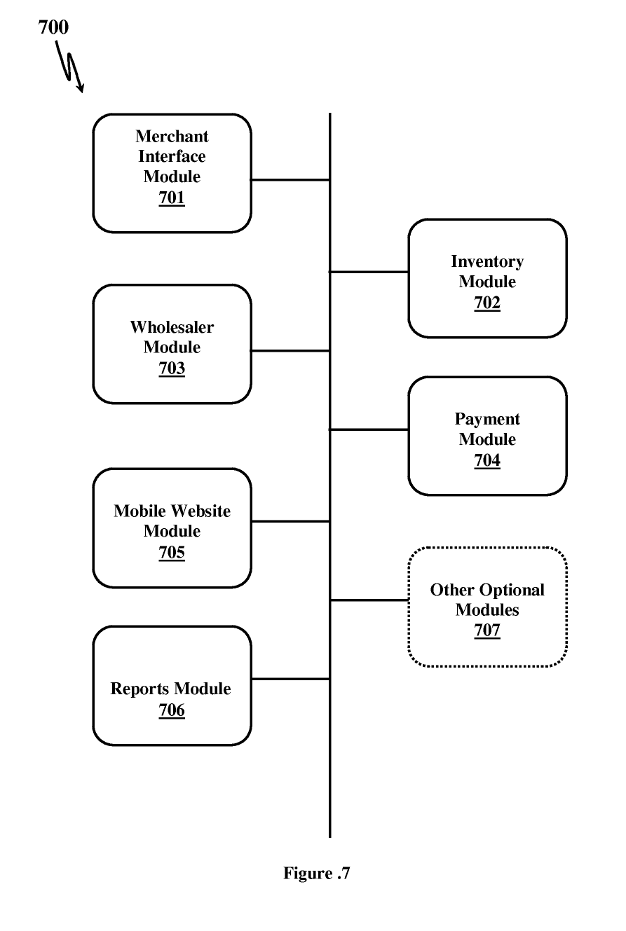

FIG. 7 illustrates a block diagram 700 of a backend server engine 203(b) in accordance with an example embodiment. The backend server engine 203(b) can be utilized to receive and store data of the products and/or services from merchants 204 and transmit data to user device 102 using the network 201. The backend server engine 203(b) can be utilized to receive and store data related to bookings, discounts and payments of the products and/or services [collectively referred herein user data] from the user device 101 and transmit the user data to the merchants 204.

The backend server engine 203(b) can include several components that may be configured to perform various operations. As shown in FIG. 7, the backend server engine 203(b) can comprise a merchant interface module 701, an inventory module 702, a wholesale module 703, a payment module 704, a mobile website module 705, a report module 706 and other optional modules 707.

In an embodiment, the merchant interface module 701 can manage all merchants 204 interactions with the backend server 203 using the interface device 202. The merchant interaction with the backend server 203 can include registration, inventory management, and reports. The merchant interface module 701 can allow the merchants to upload and manage the details/data of the products and/or services to the backend server 203.

In an embodiment, the inventory module 702 can manage calendars for availability and pricing. The availability of products and/or services can be represented in an extensive way like number of rooms, number of cars for rental, number of taxis, number of vacation rental homes, genre of movies, and cuisines.

In an embodiment, the wholesaler module 703 can send availability of products and/or services and prices from the backend server 203 to the user device 102 based on a real-time request from the user 101. The wholesaler module 703 can also perform booking, modification, and cancellation functions based on the instruction received from user device 102. The wholesaler can be automated through XML APIs.

In an embodiment, the payment module 704 can process payment transactions based on instruction received from the user device 102. The payment link between the user 101 and merchants 204 can be established through the payment module 704 in the backend server engine 203.

In an embodiment, mobile website module 706 can reuse the backend server 203 functions to retrieve available products and/or services and to process payments.

In an embodiment, reports module 706 can generate on-demand reports for the merchants 204 and system staff. Specifically, the reports can contain details of bookings, modifications, and cancellations; revenue, cost of booking, user details, payment details, price charged to user and driving discounts given, and app usage details.

The foregoing description of the specific embodiments will so fully reveal the general nature of the embodiments herein that others can, by applying current knowledge, readily modify and/or adapt for various applications. Such specific embodiments without departing from the generic concept, and therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A method of providing discounts for services and/or products, the method comprising:
allowing a user to select and book at least a service and/or product using a user device;
using the user device, identifying position of the user and a destination of services and/or products are available;
calculating a predetermined radius from the destination, wherein the predetermined radius is an origin;
calculating “as-the-crow-flies” travel distance of the user towards the destination during the travel within the origin;
applying discounts on basic price of the booked service and/or product, wherein the discounts are dynamically applied based on the travel distance to determine dynamic discounted price;
allowing the user to avail the discounts for the booked service and/or product; and
allowing the user to make or authorize payment for the booked service and/or product.

2. The method as claimed in claim 1 further comprises not applying the discounts upon reaching a predetermined distance from the destination, wherein the predetermined distance is a curbside.

3. The method as claimed in claim 2 further comprises applying minimum amount of the discounts at start of the origin, applying further discounts up to the curbside while traveling towards the destination, and applying maximum amount of the discounts upon reaching the curbside.

4. The method as claimed in claim 1 further comprises not applying the discounts while the user is traveling away from the destination.

5. The method as claimed in claim 1 further comprises not applying the discounts in outside the origin region.

6. The method as claimed in claim 1 further comprises of stopping and marking the discounts while the user stops at any place before reaching the destination, and restarting the discounts from the marked discounts while the user starts traveling towards the destination.

7. The method as claimed in claim 3, wherein the payment is made for dynamic discounted price of the booked service and/or product during travel towards the destination within the origin.

8. The method as claimed in claim 3, wherein the payment is made or authorized for basic price of the booked service and/or product in advance before traveling to the destination and in outside the origin region.

9. The method as claimed in claim 7, wherein the user avails the further discounts as refund from the payment made.

10. The method as claimed in claim 8, wherein the user avails the discounts as refund from the payment made.

11. The method as claimed in claim 8, wherein the user completes the payment transaction after deducting the applied discounts from the authorized payment.

12. The method as claimed in claim 1, wherein the user device is configured to display data of the services and/or products based on position of the user.

13. The method as claimed in claim 1, wherein the user device is integrated with a global positioning system [GPS] receiver capable of identifying and tracking the position.

14. The method as claimed in claim 1, wherein the user device is in connection and communication with a navigation system capable of identifying and tracking the position.

15. The method as claimed in claim 14, wherein the user travels to the destination using a travel mode, wherein the travel mode includes walking and driving using a vehicle, wherein the navigation system is made available in the vehicle.

16. A system of providing discounts for services and/or products, the system comprising
at least a user device which includes a booking discount engine;
a network;
a backend server which includes a database and a backend server engine; and
at least an interface device for permitting merchants to interact with the backend server,
wherein the database stores data related to the services and/or products, wherein the interface device facilitates transmitting and receiving the data from the backend server over the network.

17. The system as claimed in claim 16, wherein the merchants upload and manage the data of the products and/or services to the database.

18. The system as claimed in claim 16, wherein the booking discount engine comprising
a user interface module that enables users to select, book, pay, modify and cancel bookings of the services and/or products, manages all user interactions dealing with capturing user requests related to the products and/or services, and display the list of available products and/or services details from the merchants;
a geo-based inventory module that receives and displays the data of products and/or services from the backend server based on the user location;
a price reduction logic module that runs at a predetermined interval to identify discounts of the products and/or services based on the user's requirements, and computes minimum amount of discount, maximum amount of discount and dynamic discounted price;
a booking module that enables the user to perform booking, modification, and cancellation functions for the products and/or services;
a navigation module that helps the user with driving directions to find the shortest path to the destination, and
a device linker module that enables to link the user device with a navigation system, in order to receive the location of the user and destination, distance between the user and destination, and the dynamic discounted price at user device from the navigation system.

19. The system as claimed in claim 16, wherein the backend server engine comprising
a merchant interface module that manages all merchant interactions with the backend server;
an inventory module that manages calendars for availability and pricing;
a wholesale module that sends availability of products and/or services and prices from the backend server to the user device based on a real-time request from the user,
a payment module that processes payment transactions based on instruction received from the user device;
a mobile website module that reuses the backend server functions to retrieve available products and/or services and to process payments; and
a report module that generates on-demand reports for the merchant and system staff.
